(19) United States
(12) Patent Application Publication
(10) Pub. No.: US 2024/0427995 A1
(43) Pub. Date: Dec. 26, 2024

(54) IDENTIFYING VISUAL TEXT USING VISION-LANGUAGE MODELS

(71) Applicant: Adobe Inc., San Jose, CA (US)

(72) Inventors: Jiuxiang GU, Baltimore, MD (US); Ryan ROSSI, San Jose, CA (US); Gaurav VERMA, Atlanta, GA (US); Christopher TENSMEYER, Fulton, MD (US); Ani NENKOVA, Philadelphia, PA (US)

(21) Appl. No.: 18/339,883

(22) Filed: Jun. 22, 2023

(51) Int. Cl. G06F 40/289; G06F 40/205; G06T 11/60

(52) U.S. Cl. CPC G06F 40/289; G06F 40/205; G06T 11/60

(57) ABSTRACT

A method includes receiving a text to be used for generating an image. The method further includes determining whether the text is a visual text using a machine learning model trained to classify whether an input text is non-visual text or visual text. The method further includes responsive to determining that the text is a visual text, generating the image using a second machine learning model based on the text. The method further includes displaying the image and the text.

### BACKGROUND

Visual graphics, such as an image, can improve a user's understanding of certain concepts or ideas. For example, an image related to text may help a user understand the text. However, not all text can be illustrated using an image. Text can be classified as being visual text, in which the text invokes an image in a user's mind. Text can also be classified as being non-visual text, in which the text cannot be further expressed using an image. Providing an image with corresponding visual text can improve the user's understanding of the text.

### SUMMARY

Introduced here are techniques/technologies that create images from text that has been identified as invoking a visual image (e.g., visual text). Specifically, a multimodal model is trained using a modified objective function. By modifying the objective function of a multimodal model, the model is able to learn to classify text without receiving a corresponding image input. The multimodal model (e.g., a vision language model such as CLIP) learns to distinguish between visual and non-visual text using contrastive learning. The training data used for contrastive learning includes pairs of visual text and corresponding images, and pairs of non-visual text and a null image. Such positive and negative pairs can be determined in a self-supervised fashion by detecting an image in a document and comparing an embedding of each sentence of the document to an embedding of the image to determine a similarity of the sentence to the image. The contrastive learning objective function used to train a standard CLIP model is modified to pair visual text with a corresponding image, and additionally pair non-visual text with a null image.

After visual text has been identified from a document, the visual text can be used to obtain a corresponding image. The image can be obtained from a data store and/or generated using any generative machine learning model. If the image is generated, the generative machine learning model benefits from receiving the image embedding determined from the multimodal model when identifying the visual text from text of a document. Reusing the same embedding to identify visual text and subsequently generate images of the visual text results in more targeted and effective generated images.

Additional features and advantages of exemplary embodiments of the present disclosure will be set forth in the description which follows, and in part will be obvious from the description, or may be learned by the practice of such exemplary embodiments.

### BRIEF DESCRIPTION OF THE DRAWINGS

The detailed description is described with reference to the accompanying drawings in which:

FIG. 1 illustrate a diagram of a process of obtaining images for text identified as being visual, in accordance with one or more embodiments;

FIG. 2 illustrates an example of training the visual text identifier to classify text, in accordance with one or more embodiments;

FIG. 3 illustrates obtaining training data used to train the CLIP model, in accordance with one or more embodiments;

FIG. 4 illustrates an example implementation of a diffusion model, in accordance with one or more embodiments;

FIG. 5 illustrates the diffusion processes used to train the diffusion model, in accordance with one or more embodiments;

FIG. 6 illustrates an example of identified visual text and a corresponding image, in accordance with one or more embodiments;

FIG. 7 illustrates an example of identifying visual and non-visual text in a document, in accordance with one or more embodiments;

FIG. 8 illustrates obtaining an image using visual text, in accordance with one or more embodiments;

FIG. 9 illustrates an example of an image-embedded document, in accordance with one or more embodiments;

FIG. 10 illustrates a schematic diagram of a text visualization system in accordance with one or more embodiments;

FIG. 11 illustrates a flowchart of a series of acts in a method of obtaining images for text identified as being visual, in accordance with one or more embodiments; and

FIG. 12 illustrates a block diagram of an exemplary computing device in accordance with one or more embodiments.

### DETAILED DESCRIPTION

One or more embodiments of the present disclosure include a text visualization system that provides images of visual text. In one conventional approach, vision language models are used to create images from text. However, these approaches are limited to creating images from a prompt including a short phrase or word. For example, conventional approaches do not work well when creating an image from a prompt including a sentence or a paragraph. Moreover, these approaches assume that the input is visual. For example, conventional solutions create images using any input, without any consideration as to whether the created image would be understandable by a human. Other conventional approaches learn relationships between text and images. For example, a machine learning model can learn to identify text, from a set of text, that is related to an image. However, during deployment, these approaches require inputs including both a set of text and a received image.

To address these and other deficiencies in conventional systems, the text visualization system of the present disclosure performs sentence level image generation using only sentences identified as being visual text. The text visualization system distinguishes between visual text and non-visual text such that only visual text is used to obtain an image.

The text visualization system parses through sentences (or other text granularities such as phrases, words, etc.) of a document to identify sentences of the document that are visual text, as opposed to non-visual text. In this manner, the text visualization system determines that the input used to create the image will result in an image understandable by a human. Images are created using a generative AI model that receives the entire sentence. The text visualization system trains a machine learning model using a modified objective function to learn relationships between text (including both visual text and non-visual text) and images. As a result of the modified objective function used during training, during deployment, the machine learning model is able to classify whether text is visual using only a null image and a sentence of text. That is, the text visualization system does not require a set of text and a received image to determine a relationship between the text and the image. The text visualization system of the present disclosure improves the efficiency of using computing resources to generate or otherwise obtain images. For example, by generating images using only text classified as being visual, the text visualization system is more likely to generate human understandable images. If the text visualization system did not first determine whether text was visual text, computing resources would be wasted generated non-human understandable images associated with non-visual text. Additionally, reusing text embeddings during the image generation process reduces computing resources required to re-generate text embeddings and further reduces a likelihood of inaccurately generated images, as the embeddings are used to fine-tune generative AI models.

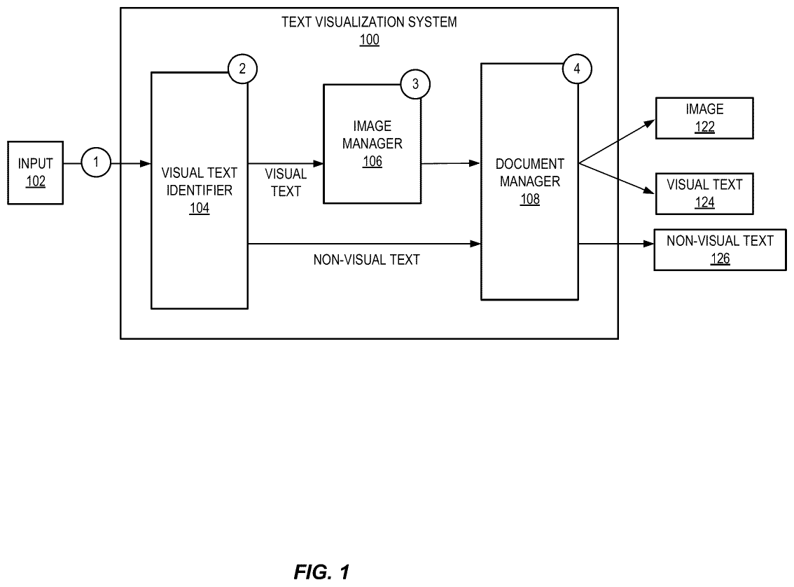

FIG. 1 illustrates a diagram of a process of obtaining images for text identified as being visual, in accordance with one or more embodiments. As shown in FIG. 1, embodiments include a text visualization system 100. The text visualization system 100 includes a visual text identifier 104, an image manager 106, and a document manager 108.

At numeral 1, the text visualization system 100 receives input 102. For example, input 102 may be uploaded to the text visualization system 100. Input 102 may be any digital text file including one or more paragraphs or collections of text. For example, the input 102 may be digital text such as a document, a book, a poster, a website, and the like. In some embodiments, the input 102 includes digital files with the following, or other file extensions: .DOC, .DOCX, .PDF, .TXT, .HTML, .RTF, or .ODT.

Text visualization system 100 may be implemented, for example, as a standalone service or within a larger application or suite of applications. For example, the user may open input 102 using a document reader application. The text visualization system 100 may be implemented as part of the document reader application. In such an example, the input 102 may be provided to the text visualization system 100 when the user selects an icon, tool, or other user interface element within the document reader application associated with the text visualization system 100.

At numeral 2, the visual text identifier 104 segments input 102 into text of any length. For example, input 102 may be a document including multiple pages, where each page includes sentences and paragraphs. The visual text identifier 104 can segment the text of the document into one or more pages, one or more paragraphs, one or more sentences, one or more phrases, one or more words, and the like. In some embodiments, a user may configure the granularity of the segmented text. For example, a user may configure a page of text included in input 102 to be segmented into paragraphs, sentences, and/or words. In some embodiments, the input 102 is pre-segmented. That is, the input 102 is received at numeral 2 in sentences, paragraphs, words, etc. In some embodiments, the visual text identifier 104 segments text using one or more natural language processing algorithms. For example, the visual text identifier 104 may execute the Natural Language ToolKit (NLTK) tokenizer to segment text (e.g., pages, paragraphs) into tokens (e.g., sentences, words).

Using the input 102 (or segments of input 102 such as sentences segmented from the input 102), the visual text identifier 104 determines whether the input 102 is visual or non-visual. As described herein, visual text is text that is strongly associated with an image. In other words, text is determined to be visual text when it invokes an image in a user's mind. To determine whether the input 102 is visual or non-visual, the visual text identifier 104 classifies the input 102. For example, the visual text identifier 104 a receives a sentence as input 102. Subsequently, the visual text identifier 104 classifiers whether the sentence is visual text or non-visual text. The visual text identifier 104 classifies a sentence as being visual text responsive to the sentence satisfying a visual text threshold. As described herein, a machine learning model determines a visual text score and subsequently the visual text identifier 104 compares the visual text score to one or more visual text thresholds.

In some embodiments, all text that does not satisfy the visual text threshold is classified as being non-visual text. In other embodiments, the visual text identifier 104 classifies the sentence as being non-visual responsive to the text satisfying a non-visual threshold. For example, the machine learning model determines a visual text score and subsequently the visual text identifier 104 compares the visual text score to the non-visual threshold. In some embodiments, the visual text identifier 104 outputs non-visual text (e.g., text satisfying the non-visual threshold or text that is not classified as visual text) as non-visual text 126. Non-visual text 126 may be the same as input 102 (or a segment of input 102 if, for instance if the input 102 was segmented into sentences or words). In other embodiments, as described herein, the document manager 108 modifies the non-visual text before non-visual text is output from the text visualization system 100.

At numeral 3, the image manager 106 obtains an image 122 using the visual text. In some embodiments, image 122 is semantically related to the visual text. In other embodiments, image 122 is an illustration of the visual text. For example, the visual text describes the obtained image 122.

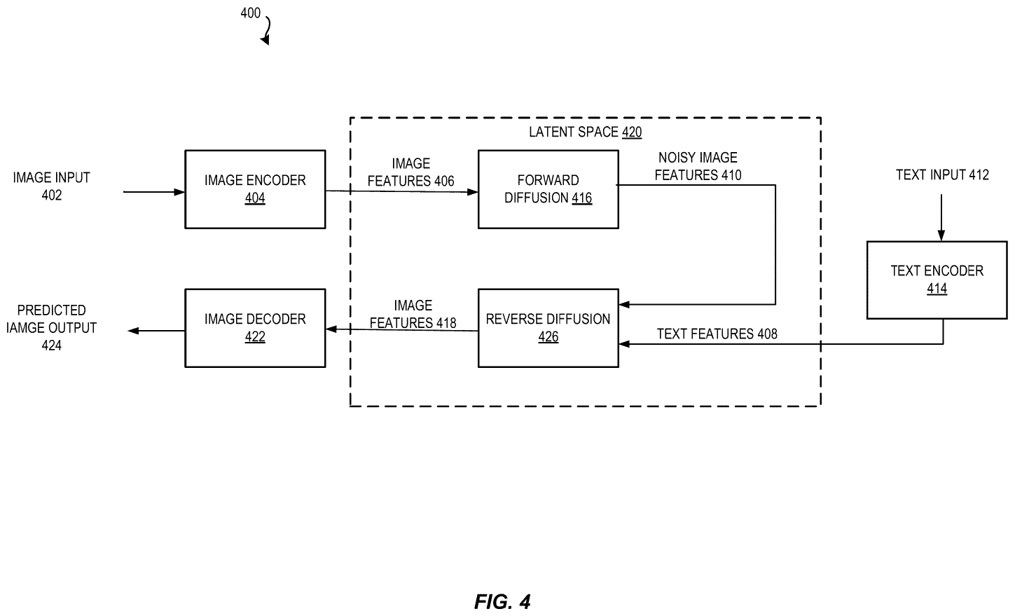

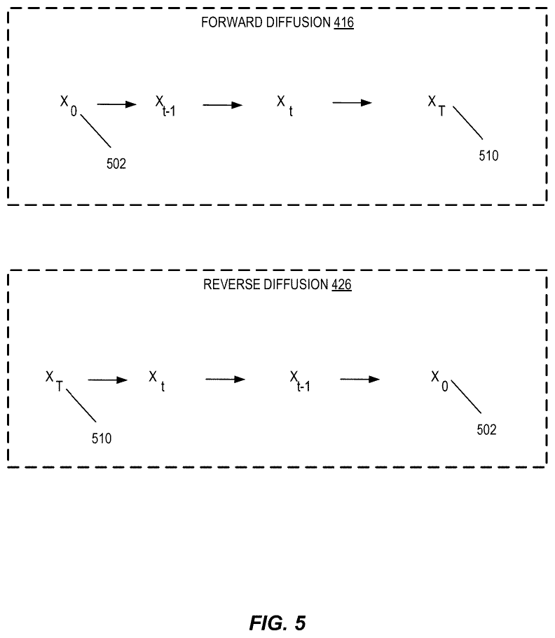

In some embodiments, the image manager 106 obtains the image by querying one or more data stores for an image using the visual text. A data store is a server, memory location, data base located internally or externally to the text visualization system 100. For example, the image manager 106 obtains the image by providing one or more words of the visual text to the data store and receiving one or more images related to the one or more words of the visual text. In other embodiments, the image manager 106 generates the image 122 using the visual text. For example, the image manager 106 may be any generative AI module configured to generate an image using the visual text as a prompt. The image manager 106 inputs the visual text (e.g., the sentence of the input 102 classified as visual text) to the generative AI module to generate an image. By providing context to the generative AI module (e.g., a sentence, as opposed to a word), the generative AI module may generate a comprehensive image that is closely associated/related with the image invoked by the visual text. Additionally or alternatively, the image manager 106 provides, as input to the generative AI model, visual text embeddings determined by the visual text identifier 104. As described herein, the visual text identifier 104 uses one or more models to determine a visual score associated with input 102 (or a segmented portion of input 102). As part of classifying the input 102 as visual text, the one or more models generate a text embedding. By providing the generative AI the text embedding used to classify visual text, the generative AI may generate a comprehensive image that is closely associated/related with the image invoked by the visual text. An example a generative AI model is described in more detail with reference to FIGS. 4-5.

At numeral 4, the document manager 108 positions the obtained image near the visual text (e.g., the input 102 classified as being visual text). For example, the obtained image may be placed in the middle of a paragraph including the visual text. Additionally or alternatively, the document manager 108 embeds the obtained image, using a hyperlink for instance, in the visual text. In this manner, when a user interacts with the visual text, the obtained image is displayed. To position the obtained image, the document manager 108 may modify one or more attributes of the visual text 124 such as font size, font, etc. In some embodiments, the document manager 108 modifies one or more attributes of the non-visual text 126 such that the document manager 108 can display image 122 next to visual text 124 (e.g., next to a paragraph including visual text 124). For example, the document manager 108 can reformat non-visual text 126 to make room for the image 122 next to the visual text 124. Additionally or alternatively, the document manager 108 modifies one or more attributes of the input 102 such as the document margin.

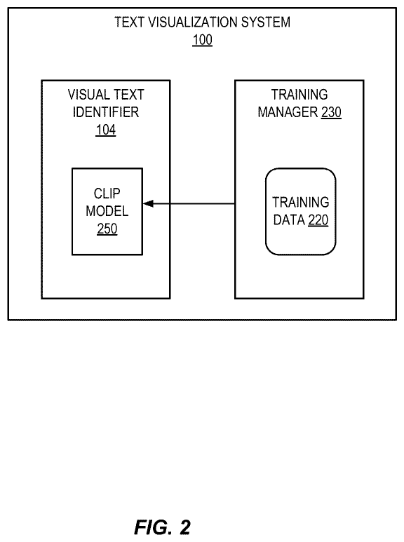

FIG. 2 illustrates an example of training the visual text identifier to classify text, in accordance with one or more embodiments. The visual text identifier 104 classifies text as either visual text or non-visual text. As shown, the visual text identifier 104 includes a contrastive learning image pretraining (CLIP) model 250. However, it should be appreciated that CLIP model 250 may be any multimodal model (e.g., a model configured to learn a task using more than one domain such as the image domain and the text domain). For example, CLIP model 250 may be a neural network. A neural network may include a machine-learning model that can be tuned (e.g., trained) based on training input to approximate unknown functions. In particular, a neural network can include a model of interconnected digital neurons that communicate and learn to approximate complex functions and generate outputs based on a plurality of inputs provided to the model. For instance, the neural network includes one or more machine learning algorithms. In other words, a neural network is an algorithm that implements deep learning techniques, i.e., machine learning that utilizes a set of algorithms to attempt to model high-level abstractions in data.

CLIP models use contrastive learning to pull similar text/image pairs together in a latent space (e.g., an image correctly described by text) and push dissimilar text/image pairs apart in the latent space (e.g., an image incorrectly described by text). Conventionally, CLIP models are trained to predict a most likely text description from a received set of text descriptions that are related to a received image. As described herein, the training manager 230 teaches the CLIP model 250 to learn to identify visual and non-visual text by modifying the objective function of the CLIP model 250. By modifying the objective function of a multimodal model, the model is able to learn to classify text without receiving a corresponding image input. For example, instead of predicting a most likely text description from a received set of text descriptions that are related to a received image, the CLIP model 250 is able to predict a most likely text classification using an image (e.g., a null image).

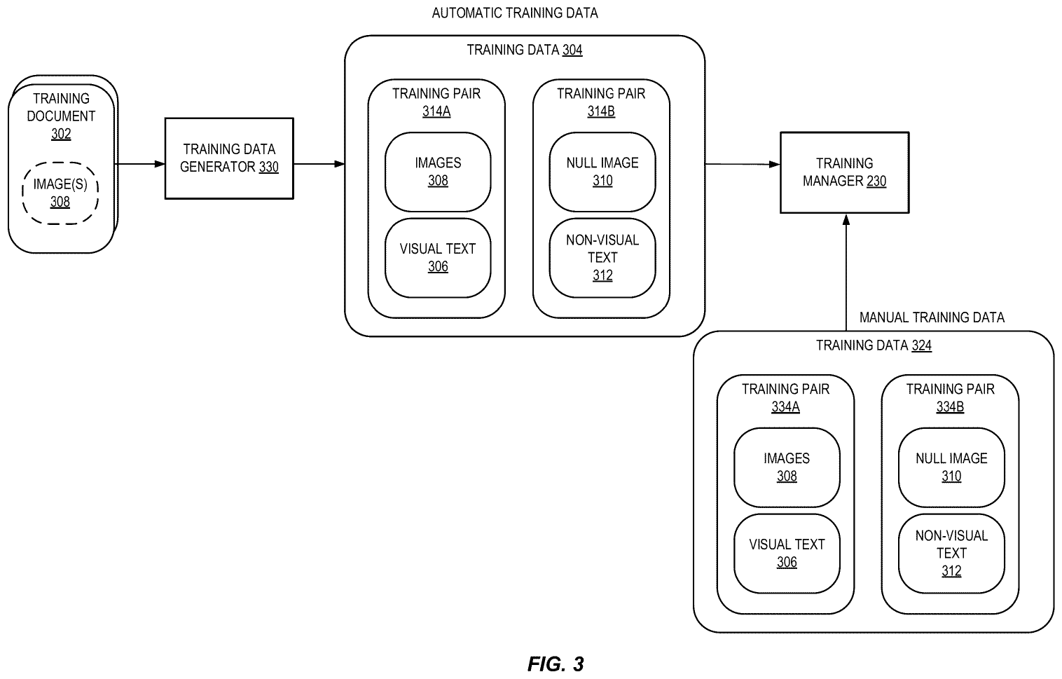

In some implementations, the training manager 230 trains the CLIP model 250 during stages of training. For example, during the first stage of training, the training manager 230 trains the CLIP model 250 using the automatic training data. As described with reference to FIG. 3, automatic training data is training data that has been automatically determined. During a second stage of training, the training manager 230 trains the CLIP model 250 using the manual training data. As described with reference to FIG. 3, manual training data is training data that has been determined using user feedback. By training the CLIP model 250 in stages, the CLIP model 250 is fine-tuned using manual training data. In other embodiments, the training manager 230 trains the CLIP model 250 using a mixture of automatic training data and manual training data.

Using the training data (e.g., the automatic training data, manual training data, or some combination), the training manager 230 trains the CLIP model 250 to identify visual and non-visual text. Specifically, the CLIP model 250 is trained using an adapted contrastive learning objective function to pair visual text with the corresponding image (e.g., an image that may be invoked from the visual text). Additionally, the CLIP model 250 is trained using the adapted contrastive learning objective function to pair non-visual text with a null image. In operation, using the adapted objective function, the CLIP model 250 learns semantic relevance between images and text embeddings.

Contrastive learning is a mechanism of learning that utilizes self-supervised learning to minimize a distance (such as Euclidean distance) between similar samples in an embedding space and maximize a distance between dissimilar samples in the embedding space. In this manner, similar samples (e.g., visual text and corresponding images, and non-visual text and null images) are pushed together, while dissimilar samples (e.g. as visual text and non-visual text) are pulled apart.

Mathematically, the adapted objective function is shown below in Equation (1)

$$L = - \frac{1}{2 N} {\sum }_{j = 1}^{N} log ( \frac{exp ( \frac{< {I}_{j}^{e} , {T}_{j}^{e} >}{τ} )}{{\sum }_{k = 1}^{N} exp ( \frac{< {I}_{j}^{e} , {T}_{j}^{e} >}{τ} )} ) - \frac{1}{2 N} {\sum }_{k = 1}^{N} log ( \frac{exp ( \frac{< {I}_{k}^{e} , {T}_{k}^{e} >}{τ} )}{{\sum }_{j = 1}^{N} exp ( \frac{< {I}_{j}^{e} , {T}_{k}^{e} >}{τ} )} ) \qquad ( 1 )$$

$$such as {I}_{m}^{e} = \{ \begin{matrix}{I}_{null}^{e} , if m ∈ non - visual text \\ {I}_{m}^{e} , if m ∈ visual text\end{matrix}$$

In Equation (1) above, N represents the number of samples in a training batch. Iₘ^{e} represents an image embedding of the m-th pair of image and corresponding text, Tₘ^{e} represents a text embedding of the m-th pair of image and corresponding text, and Iₙᵤₗₗ^{e}, represents the image embedding of the null image. As shown, <,> represents a dot product, and t represents a trainable temperature parameter. The adapted objective function trains the CLIP model 250 to maximize a cosine similarity between embeddings of correct image text pairs (e.g., visual text and corresponding images, non-visual text and null images) and minimize a cosine similarity between incorrect image text pairs (e.g., non-visual text and images, visual text and null images).

By training the CLIP model 250 to anchor non-visual text to the null image, during inference, the CLIP model 250 can be used to identify non-visual text by identifying sentences with a high similarity to that of the null image. For example, the CLIP model 250 takes the cosine similarity of each sentence of a page (e.g., segments of the input 102) and compares each sentence to the null image. As a result, the CLIP model 250 returns a probability of each sentence of the page being similar to the null image. Subsequently, the visual text identifier 104 can classify visual text by determining sentences that are dissimilar to the null image (e.g., a reciprocal of a similarity score). Mathematically, this can be expressing using Equation (2) below.

$$Visual Score = 1 - < {I}_{null ,}^{e} , {T}^{e} > \qquad ( 2 )$$

A visual score, determined according to Equation (2), satisfying a similarity threshold may indicate that the text is visual text. Training the CLIP model 250 using a contrastive learning function trains the CLIP model 250 to learn a matching task, where the visual text is matched with an image and the non-visual text is matched to a null image. In this manner, the CLIP model 250 learns to categorize unseen text into visual and non-visual text depending on how strongly (or weekly) a text is matched with the NULLL image. Because the CLIP model 250 is trained to learn a matching task using contrastive learning (as opposed to a classification objective which is conventionally learned using a cross-entropy loss function), the CLIP model 250 learns to match visual text with a corresponding image, facilitating the text visualization system 100 ability to perform image retrieval. The contrastive learning objective function, described herein, can both categorize text as being visual text or non-visual text, while also preserving cross-modal (e.g., text to image) retrieval abilities.

In some embodiments, the training manager 230 trains the CLIP model 250 using pairs of non-visual text and a common null image (instead of a randomly generated null image associated with the non-visual text), and pairs of visual text and a common image (instead of an image used to illustrate the visual text, as obtained by the training data generator 330 as described herein). In these embodiments, the CLIP model 250 learns a binary classification of visual text and non-visual text (as opposed to learning to perform matching, as described herein). As a result, the CLIP model 250 does not learn how to classify a document using both positive examples (visual text and corresponding images) and negative examples (non-visual text and a null image).

FIG. 3 illustrates obtaining training data used to train the CLIP model, in accordance with one or more embodiments. In some embodiments, the training manager 230 obtains training data including training pair 314A (e.g., visual text 306 and corresponding images 308 (e.g., images invoked by the visual text)) from one or more data stores. For example, the training manager 230 queries a datastore for training data including visual text 306 and corresponding images 308. In other embodiments, the training manager 230 obtains training data 304 from the training data generator 330. The training data generator 330 generates training data 304 by determining training pair 314A and training pair 314B. Specifically, the training data generator 330 generates training pair 314A using extracted visual text 306 and images 308 from one or more documents 302. The training data generator 330 also determines training pair 314B using non-visual text 312 from the document 302. The null image 310 of training pair 314B may be generated by the training data generator 330, uploaded to the text visualization system 100, or the like. As shown, some documents 302 (or some portions of document 302) may include one or more images 308. The training data generator 330 determines which documents 302 (or which portions of documents 302) include images 308 as described herein. The training data generator 330 generates training data 304 using self-supervised learning.

The document 302 (e.g., a training text) is any digital text file including one or more paragraphs or collections of text. For example, the document 302 may be digital text such as a book, a poster, a website, and the like. One or more portions of the document may include one or more images 308. For example, a document may include multiple pages of text, where some of the pages of text include one or more images 308. The training data generator 330 can obtain the document 302 from one or more data stores. Additionally or alternatively, documents 302 may be uploaded to the training data generator 330. The training data generator 330 performs object detection to determine whether a page of the document 302 includes an image 308. For example, the training data generator 330 can execute any convolutional neural network (CNN) such as region-CNN (R-CNN), fast R-CNN, faster R-NN, and the like to identify objects in a page, if any. If the page includes an object, the training data generator 330 determines that the document 302 includes an image 308. In some embodiments, the training data generator 330 uses a document object detection tool like Fitz to identify and extract images 308 from the document 302.

After the training data generator 330 has determined that the document 302 includes an image 308, the training data generator 330 further analyzes the document 302 to determine a description of the identified image (e.g., the text corresponding to the image 308, or visual text 306).

In some embodiments, the training data generator 330 further analyzes the document 302 including the image 308 by segmenting the document 302. For example, the training data generator 330 performs sentence segmentation using any suitable mechanism (e.g., NLTK Tokenizer described above) to segment each sentence in the document 302. In other embodiments, different or other text granularities such as phrases, words, etc. are segmented in the document 302. Subsequently, the training data generator 330 determines a similarity of each sentence to the image 308 using a vision language model such as a CLIP model.

A sentence is paired with the image 308 if the training data generator 330 determines that the similarity score of a sentence and the image satisfies a similarity threshold. The similarity threshold may be manually determined (e.g., an input determined a user) or dynamically determined by the training data generator 330 over time. In some embodiments, the similarity threshold may empirically be determined to produce a top k % of sentences similar to an image.

Using the similarity threshold, the training data generator 330 can determine sentences that are similar to each image on a page. For example, the training data generator 330 pairs a sentence and an image 308 if the training data generator 330 determines that the similarity score of the sentence and any image 308 on the page is greater than the similarity threshold. Such training data, created without any user feedback is considered “automatic training data.” The sentences that are similar to the image 308 are considered visual text 306. In this manner, the training data generator 330 generates training pair 314A of visual text 306 and corresponding images 308. In some embodiments, the training manager 230 determines automatic training data by pairing a sentence with a common image. For example, a single image is selected by the training data generator 330 as a common image to pair with any visual text 306.

The training data generator 330 may also determine sentences that are least related to the image on the page (e.g., dissimilar sentences and images). By identifying sentences that are dissimilar to images, the training data generator 330 is identifying non-visual text 312. The training non-visual text 312 is used by the training manager 230 (of FIG. 2) to teach CLIP model 250 (of FIG. 2) to identify non-visual text (e.g., sentences that do not invoke an image) in a document.

In some embodiments, the training data generator 330 determines a sentence that is dissimilar to an image when the similarity score between the sentence and the image satisfies a negative similarity threshold. The negative similarity threshold may be manually determined (e.g., an input determined a user) or dynamically determined by the training data generator 330 over time. In one example implementation, the negative similarity threshold may empirically be determined to produce a bottom n % of sentences that are dissimilar to the image 308. If there are multiple images on a page of the document 302, the training data generator 330 can determine a sentence that is least related to all images by comparing the similarity score of the sentence and each image on the page. In some embodiments, the training data generator 330 determines the most dissimilar sentence (e.g., non-visual text 312) by identifying the lowest similarity score. In other embodiments, the training data generator 330 determines multiple dissimilar sentences (e.g., non-visual text 312) by identifying any sentences that satisfy the negative similarity threshold.

After finding sentences that are the least related to one or more images on the page, the training data generator 330 creates training pair 314B of training data 304 by pairing non-visual text 312 with a null image 310. In some embodiments, the training data generator 330 generates the null image 310 by creating an image where each pixel in the image is a randomly selected value. In some embodiments, for each sentence that is identified as being non-visual text, the training data generator 330 generates a new null image 310. In other embodiments, the same null image 310 (e.g., a common null image) is applied to each sentence identified as being non-visual text 312. Because training pairs 314B of non-visual text 312 and null images 310 are determined by the training data generator 330 without any user feedback, such training data is considered “automatic training data.”

In some embodiments, the training manager 230 obtains training data 324 using user feedback. Obtaining training data 324 using user feedback is considered “manual training data.” For example, a user may manually rate a similarity of a sentence with one or more images on a page. In this manner, a user creates training pair 334A by manually identifying sentences (e.g., visual text 306) that invokes image 308. Additionally or alternatively, a user may manually rate a dissimilarity of a sentence to one or more images on a page. In this manner, a user creates training pair 334B by manually identifying non-visual sentences (e.g., non-visual text 312) to be paired with null image 310.

FIG. 4 illustrates an example implementation of a diffusion model, in accordance with one or more embodiments. As described herein, any generative AI can be executed to generate an image related to visual text using the image manager 106. In some embodiments, such generative AI is performed using a diffusion model.

A diffusion model is one example architecture used to perform generative AI. Generative AI involves predicting features for a given label. For example, given a label (or natural prompt description) “cat”, the generative AI module determines the most likely features associated with a “cat.” The features associated with a label are determined during training using a reverse diffusion process in which a noisy image is iteratively denoised to obtain an image. In operation, a function is determined that predicts the noise of latent space features associated with a label.

During training (e.g., using training manager 230 for instance), an image (e.g., an image of a cat) and a corresponding label (e.g., “cat”) are used to teach the diffusion model features of a prompt (e.g., the label “cat”). As shown in FIG. 4, an input image 402 and a text input 412 are transformed into latent space 420 using an image encoder 404 and a text encoder 414 respectively. After the text encoder 414 and image encoder 404 have encoded text input 412 and image input 402 respectively, image features 406 and text features 408 are determined from the image input 402 and text input 412 accordingly. The latent space 420 is a space in which unobserved features are determined such that relationships and other dependencies of such features can be learned. In some embodiments, the image encoder 404 and/or text encoder 414 are pretrained. In other embodiments, the image encoder 404 and/or text encoder are trained jointly.

Once image features 406 have been determined by the image encoder 404, a forward diffusion process 416 is performed according to a fixed Markov chain to inject gaussian noise into the image features 406. The forward diffusion process 416 is described in more detail with reference to FIG. 5. As a result of the forward diffusion process 416, a set of noisy image features 410 are obtained.

The text features 408 and noisy image features 410 are algorithmically combined in one or more steps (e.g., iterations) of the reverse diffusion process 426. The reverse diffusion process 426 is described in more detail with reference to FIG. 5. As a result of performing reverse diffusion, image features 418 are determined, where such image features 418 should be similar to image features 406. The image features 418 are decoded using image decoder 422 to predict image output 424. Similarity between image features 406 and 418 may be determined in any way. In some embodiments, similarity between image input 402 and predicted image output 744 is determined in any way. The similarity between image features 406 and 418 and/or images 402 and 424 are used to adjust one or more parameters of the reverse diffusion process 426.

As shown, training the diffusion model 400 is performed without a word embedding. In some embodiments, training the diffusion model 400 is performed with a word embedding. For example, the diffusion model can be fine-tuned using word embeddings. A neural network or other machine learning model may transform the text input 412 into a word embedding, where the word embedding is a representation of the text. Subsequently, the text encoder 414 receives the word embedding and the text input 412. In this manner, the text encoder 414 encodes text features 408 to include the word embedding. The word embedding provides additional information that is encoded by the text encoder 414 such that the resulting text features 408 are more useful in guiding the diffusion model to perform accurate reverse diffusion 426. In this manner, the predicted image output 424 is closer to the image input 402.

When the diffusion model is trained with word embeddings, the diffusion model can be deployed during inference to receive word embeddings. As described herein, the text received by the diffusion model during inference is a user-configurable granularity (e.g., a paragraph, a sentence, etc.) When the diffusion model receives the word embedding, the diffusion model receives a representation of the important aspects of the text. Using the word embedding in conjunction with the text, the diffusion model can create an image that is relevant/related to the text. Word embeddings determined during an upstream process (e.g., during classification of an input 102 as a visual text) can be reused downstream (e.g., during text-to-image retrieval performed by the trained diffusion model).

FIG. 5 illustrates the diffusion processes used to train the diffusion model, in accordance with one or more embodiments. The diffusion model may be implemented using any artificial intelligence/machine learning architecture in which the input dimensionality and the output dimensionality are the same. For example, the diffusion model may be implemented according to a u-net neural network architecture.

As described herein, a forward diffusion process adds noise over a series of steps (iterations t) according to a fixed Markov chain of diffusion. Subsequently, the reverse diffusion process removes noise to learn a reverse diffusion process to construct a desired image (based on the text input) from the noise. During deployment of the diffusion model, the reverse diffusion process is used in generative AI modules to generate images from input text. In some embodiments, an input image is not provided to the diffusion model.

The forward diffusion process 416 starts at an input (e.g., feature Xo indicated by 502). Each time step t (or iteration) up to a number of T iterations, noise is added to the feature x such that feature X_{T} indicated by 510 is determined. As described herein, the features that are injected with noise are latent space features. If the noise injected at each step size is small, then the denoising performed during reverse diffusion process 426 may be accurate. The noise added to the feature X can be described as a Markov chain where the distribution of noise injected at each time step depends on the previous time step. That is, the forward diffusion process 416 can be represented mathematically q(x_{1:T}|x₀)=Πₜ₌₁^{T}q(xₜ|xₜ₋₁).

The reverse diffusion process 426 starts at a noisy input (e.g., noisy feature X_{T} indicated by 510). Each time step t, noise is removed from the features. The noise removed from the features can be described as a Markov chain where the noise removed at each time step is a product of noise removed between features at two iterations and a normal Gaussian noise distribution. That is, the reverse diffusion process 526 can be represented mathematically as a joint probability of a sequence of samples in the Markov chain, where the marginal probability is multiplied by the product of conditional probabilities of the noise added at each iteration in the Markov chain. In other words, the reverse diffusion process 426 is p_{θ}(x_{0:T})=p(xₜ)Πₜ₌₁^{T}p_{θ}(xₜ₋₁|xₜ), where p(xₜ)=N(xₜ;0,1).

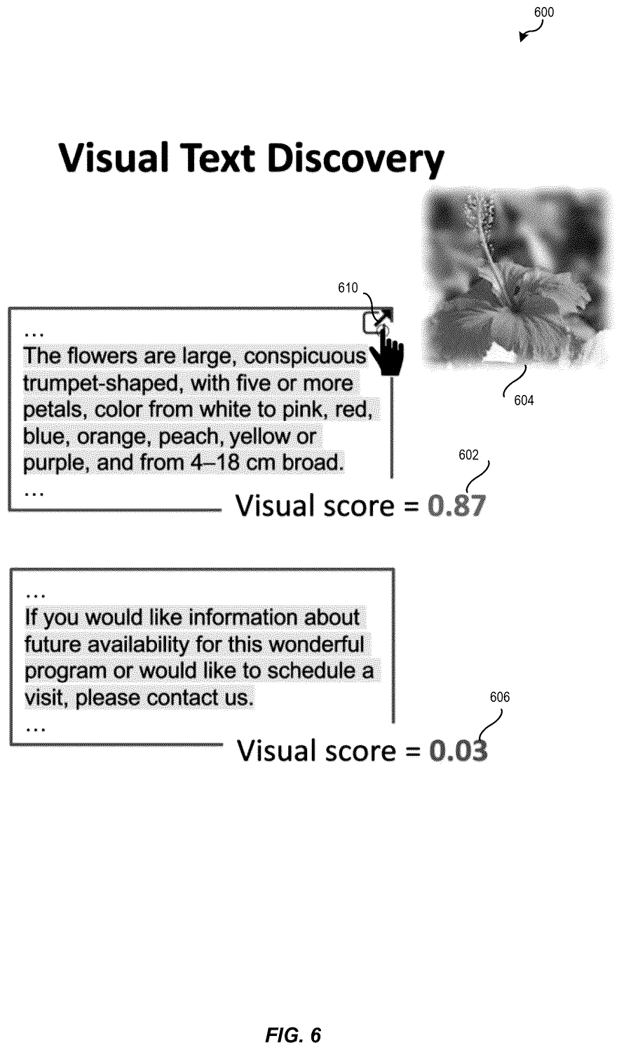

FIG. 6 illustrates an example of identified visual text and a corresponding image, in accordance with one or more embodiments. As shown, the text visualization system 100 is configured to evaluate the visualness/non-visualness of sentences. That is, input 102 (e.g., a document) is segmented into sentences such that the text visualization system 100 evaluates whether a sentence is visual or not.

As described herein, a sentence in the document is fed to the text visualization system 100. Subsequently, the visual text identifier 104 determines a visual score of the sentence. As shown at 602, a first sentence result in a visual score of 0.87. As shown at 606, a second sentence results in a visual score of 0.03. The visual score of the first sentence 602 satisfies a visual text threshold. As a result, the image manager 106 of the text visualization system 100 obtains an image 604 associated with the first sentence. In some implementations, a user interacts with button 610 to obtain the image 604 associated with the first sentence. In other implementations, responsive to a visual score satisfying a visual score threshold, an image associated with the sentence is obtained (e.g., by the image manager 106).

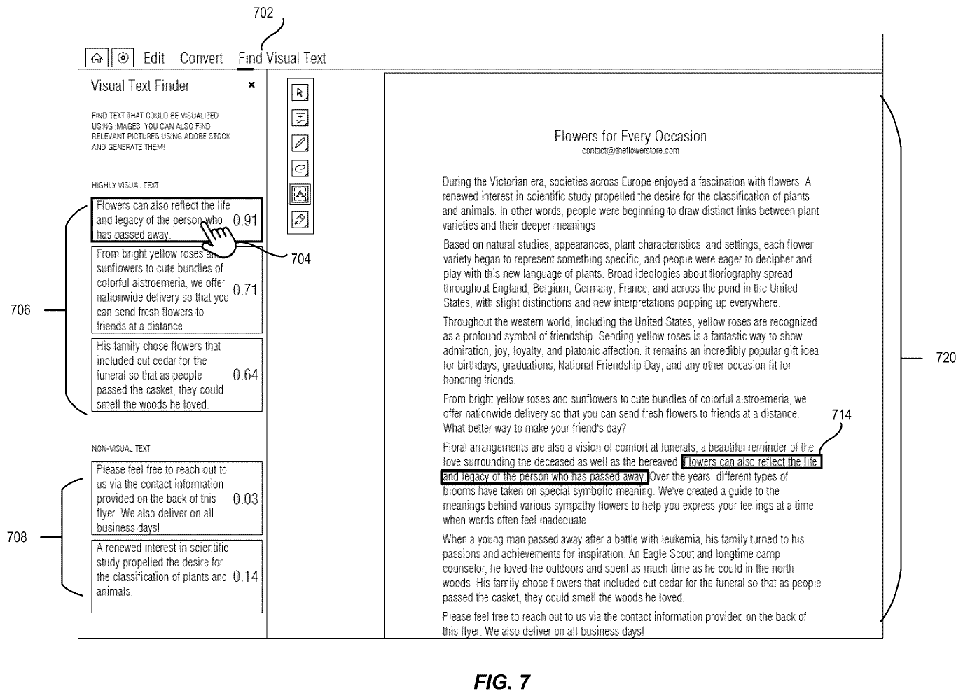

FIG. 7 illustrates an example of identifying visual and non-visual text in a document, in accordance with one or more embodiments. As shown, a document 720 is analyzed by the text visualization system 100. In some embodiments, the user executes the text visualization system 100 responsive to interacting with a button or other setting. For example, a user may select a “Find Visual Text” tab 702 when viewing the document 720. Responsive to executing the text visualization system 100, visual text is identified at 706, and non-visual text is identified at 708. In some embodiments, non-visual text is any text (e.g., sentences) that is not identified as being visual text. In other embodiments, non-visual text is identified as text (e.g., sentences) that satisfy a threshold. For example, a user may configure a non-visual text threshold. As shown at 704, a user may interact with text identified as being visual text. While not shown, it should be appreciated that the user may interact with text identified as being non-visual text. Interacting with such text includes hovering over the text using a cursor, interacting with the text (using a cursor or finger), pressing a keyboard input, etc.). When the text is interacted with at 704, the corresponding text 714 of the document 720 is indicated. For example, the corresponding text 714 is highlighted such that a visual indicator is overlaid on the text of the document 720.

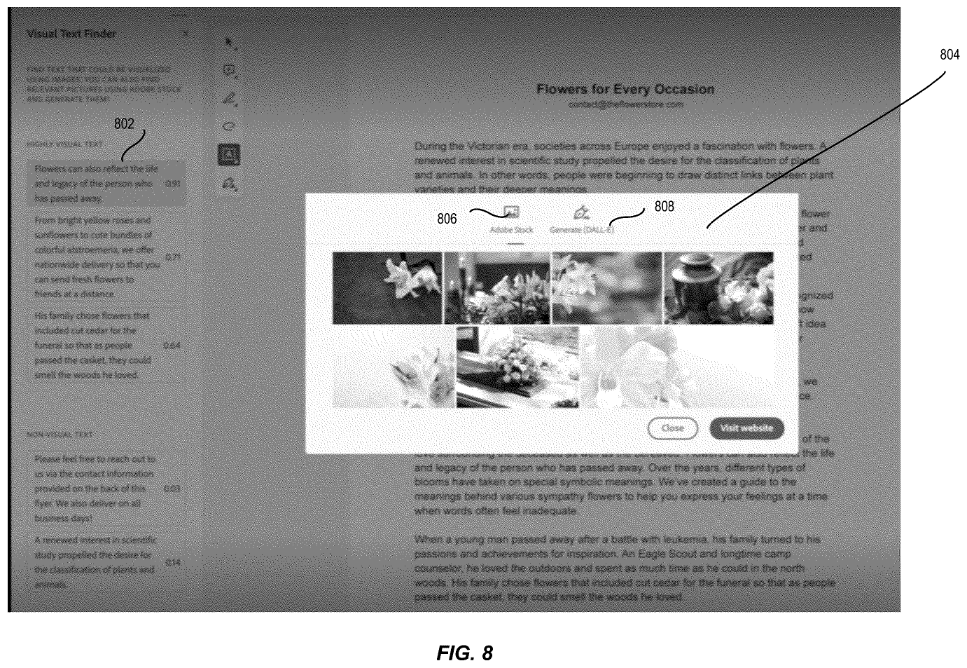

FIG. 8 illustrates obtaining an image using visual text, in accordance with one or more embodiments. As described herein, text identified as being visual text can be used to obtain an image. As shown, a user may interact with visual text 802 to obtain images related to such visual text. For example, a user may select visual text 802 by clicking on the text (e.g., using a finger or a cursor). As described herein, the image manager 106 may query a data store and/or generate images using any image generation technique to obtain images related to the visual text. As shown at 806, a user may determine to retrieve images related to the visual text from a database. Alternatively, at 808, the user may determine to generate images related to the visual text using a machine learning model. As described herein, the generated images are based on a text embedding associated with the visual text.

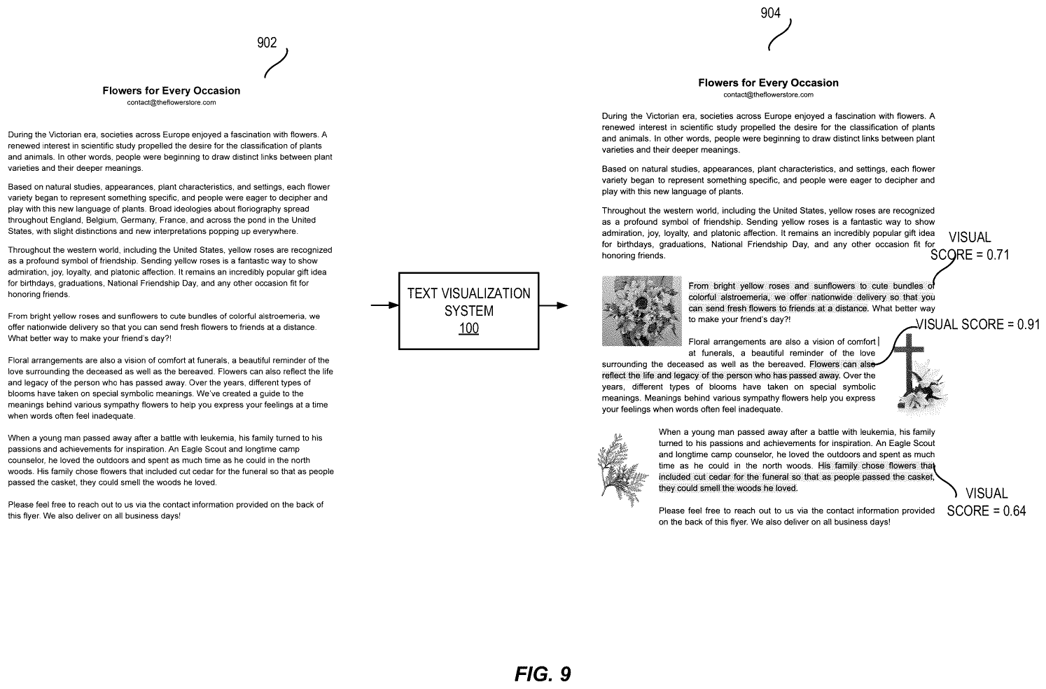

FIG. 9 illustrates an example of an image-embedded document, in accordance with one or more embodiments. A document 902 is fed to the text visualization system 100. As a result, the text visualization system 100 produces document 904 which embeds images related to visual text identified in document 902. As shown, each sentence identified as being visual text includes a visual score. In other implementations, each sentence identified as being visual text does not include the visual score and instead only the images related to the visual text is displayed. In some embodiments, a document manager 108 of the text visualization system reformats the text of the document 902 such that images related to the visual text can be displayed next to the paragraph including the text identified as being visual. As shown, the document manager 108 positions the obtained images next to the paragraphs including the identified visual text. Additionally, the document manager maintains the margins of the image/text of the document.

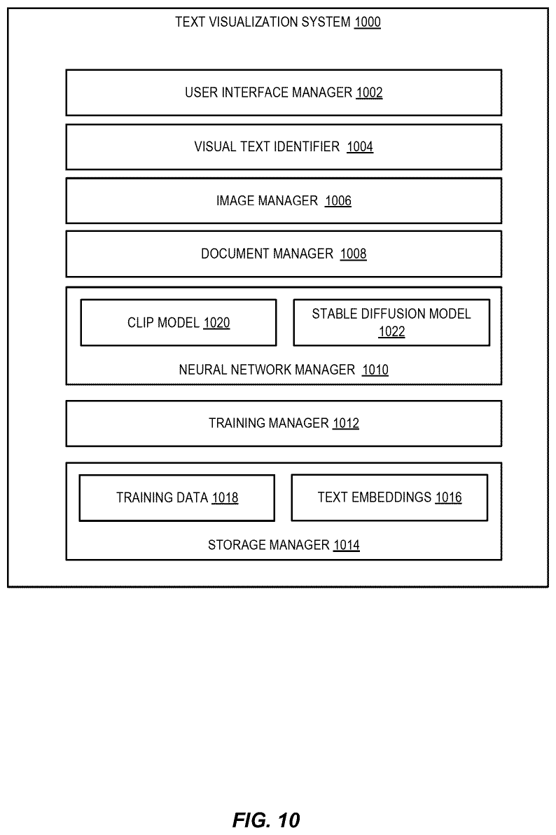

FIG. 10 illustrates a schematic diagram of text visualization system (e.g., “text visualization system” described above) in accordance with one or more embodiments. As shown, the text visualization system 1000 may include, but is not limited to, a user interface manager 1002, a visual text identifier 1004, an image manager 1006, a document manager 1008, a neural network manager 1010, a training manager 1012, and a storage manager 1014. The neural network manager 1010 includes a multimodal model such as a vision-language model and any generative AI model. In one implementation, the neural network manager 1010 includes a CLIP model 1020 and a stable diffusion model 1022.

As illustrated in FIG. 10, the text visualization system 1000 includes a user interface manager 1002. For example, the user interface manager 1002 allows users to provide input text data to the text visualization system 1000. In some embodiments, the user interface manager 1002 provides a user interface through which the user can upload the input text, which represents the text to be augmented using images corresponding to visual text, as discussed above.

Additionally, the user interface manager 1002 allows users to observe one or more proposed images associated with text identified as being visual text. For example, a user may augment the text to be consumed by one or more additional users (e.g., a target consumer). In these implementations, the text visualization system acts to predict and/or generate one or more images that are relevant to the text (e.g., associated with visual text). For example, a user (e.g., a designer) uses the user interface manager 1002 to select a proposed image associated with visual text from a plurality of proposed images associated with visual text. Subsequently, users (e.g., consumer users) are displayed the augmented text (e.g., the text with the selected image). In other implementations, a user augments the text to improve the user's comprehension of the text. For example, a consumer may improve an understanding of the document by determining to augment the document with images.

As illustrated in FIG. 10, the text visualization system 1000 includes a visual text identifier 1004. The visual text identifier 1004 can partition (or otherwise parse/segment) a received text into a user configurable granularity. For example, the visual text identifier 1004 can segment sentences in a paragraph or parse a sentence into individual words.

The text visualization system 1000 also includes a multimodal model such as CLIP to classify the text as being visual text or non-visual text. The CLIP model is trained using an adapted contrastive learning objective function to pair visual text with the corresponding image. Additionally, the CLIP model is trained using the adapted contrastive learning objective function to pair non-visual text with a null image. In operation, using the adapted objective function, the CLIP model learns semantic relevance between images and text embeddings.

The text visualization system 1000 also includes an image manager 1006. The image manager 1006 obtains an image using text classified as visual text. In some embodiments, the image manager 1006 obtains the image by querying one or more data stores for an image using the visual text identified. In other embodiments, the image manager 1006 generates the image using the visual text. For example, the image manager 1006 may be any generative AI module configured to generate an image using the visual text as a prompt.

The text visualization system 1000 also includes a document manager 1008. The document manager 1008 positions the obtained image near the visual text. For example, the obtained image may be placed in the middle of a paragraph including the identified visual text. Additionally or alternatively, the document manager 1008 embeds the obtained image, using a hyperlink for instance, in the identified visual text. To position the obtained image, the document manager 1008 may modify one or more attributes of the text such as font size, font, etc. Additionally or alternatively, the document manager 1008 modifies one or more attributes of the document including the text such as the document margin.

As illustrated in FIG. 10, the text visualization system 1000 also includes a neural network manager 1010. Neural network manager 1010 may host a plurality of neural networks or other machine learning models, such as any multimodal model (including CLIP 1020). As described herein, the CLIP model 1020 is executed by the visual text identifier 1004. The neural network manager 1010 may also host any text-to-image machine learning model (such as any generative AI model including stable diffusion model 1022) executed by the image manager 1006. The neural network manager 1010 may include an execution environment, libraries, and/or any other data needed to execute the machine learning models. In some embodiments, the neural network manager 1010 may be associated with dedicated software and/or hardware resources to execute the machine learning models. Although depicted in FIG. 10 as being hosted by a single neural network manager 1010, in various embodiments the neural networks may be hosted in multiple neural network managers and/or as part of different components. For example, the CLIP model 1020 and stable diffusion model 1022 can be hosted by their own neural network manager, or other host environment, in which the respective neural networks execute, or the CLIP model 1020 and stable diffusion model 1022 may be spread across multiple neural network managers depending on, e.g., the resource requirements of each machine learning model, etc.

As illustrated in FIG. 10 the text visualization system 1000 also includes training manager 1012. The training manager 1012 can teach, guide, tune, and/or train one or more neural networks. As described herein, the training manager 1012 can obtain training data automatically, by determining positive and negative pairs of images and text. Specifically, as described herein, the training manager 1012 can determine training data in a self-supervised manner. For example, the training manager 1012 can determine a positive pair including an image and a corresponding visual text. Similarly, the training manager 1012 can determine a negative pair including a null image and non-visual text. The training manager 1012 can also obtain training data manually responsive to user feedback.

As described herein, the training manager 1012 can train a multimodal model (such as CLIP 1020) in stages. For example, during a first stage of training, the training manager 1012 trains the CLIP model on training data that is automatically obtained. Subsequently, during a second stage of training, the training manager 1012 trains the CLIP model on training data that is manually obtained. As described herein, a training data generator may obtain training data used to train the CLIP model. The training manager 1012 trains CLIP using contrastive learning to pull corresponding text/image pairs together in a latent space (e.g., an image correctly described by text) and push dissimilar text/image pairs apart in the latent space. Specifically, the objective function used during contrastive learning is adapted. By adapting the objective function, the training manager 1012 trains CLIP to push similar samples together (e.g., visual text and corresponding images, and non-visual text and null images), while pulling dissimilar samples apart (e.g., as visual text and non-visual text).

As illustrated in FIG. 10, the text visualization system 1000 also includes the storage manager 1014. The storage manager 1014 maintains data for the text visualization system 1000. The storage manager 1014 can maintain data of any type, size, or kind as necessary to perform the functions of the text visualization system 1000. The storage manager 1014, as shown in FIG. 10, includes the training data 1018 and visual text embeddings 1016.

As described herein, the training manager 1012 obtains training data automatically and/or manually. The storage manager 1014 stores the training data 1018 such that the training manager 1012 can train the visual text identifier 1004 (and specifically the CLIP model executed by the visual text identifier 1004) in training stages. As described herein, part of training data 1018 includes text identified as being visual text and corresponding images. Training data 1018 also includes text identified as being non-visual text and a null image.

The storage manager 1014 also stores text embeddings 1016. As described herein, the generative AI model (executed by the image manager 1006) may benefit from receiving text embeddings determined by the CLIP model (executed by the visual text identifier 1004). Reusing such embeddings conserves computational resources.

Each of the components 1002-1018 of the text visualization system 1000 may be in communication with one another using any suitable communication technologies. It will be recognized that although components 1002-1018 are shown to be separate in FIG. 10, any of components 1002-1018 may be combined into fewer components, such as into a single facility or module, divided into more components, or configured into different components as may serve a particular embodiment.

The components 1002-1018 can comprise software, hardware, or both. For example, the components 1002-1018 can comprise one or more instructions stored on a computer-readable storage medium and executable by processors of one or more computing devices. When executed by the one or more processors, the computer-executable instructions of the text visualization system 1000 can cause a client device and/or a server device to perform the methods described herein. Alternatively, the components 1002-1018 can comprise hardware, such as a special purpose processing device to perform a certain function or group of functions. Additionally, the components 1002-1018 can comprise a combination of computer-executable instructions and hardware.

Furthermore, the components 1002-1018 of the text visualization system 1000 may, for example, be implemented as one or more stand-alone applications, as one or more modules of an application, as one or more plug-ins, as one or more library functions or functions that may be called by other applications, and/or as a cloud-computing model. Thus, the components '1002-1018 of the text visualization system 1000 may be implemented as a stand-alone application, such as a desktop or mobile application. Furthermore, the components 1002-1018 of the text visualization system 1000 1000 may be implemented as one or more web-based applications hosted on a remote server. Alternatively, or additionally, the components of the text visualization system 1000 may be implemented in a suite of mobile device applications or “apps.”

As shown, the text visualization system 1000 can be implemented as a single system. In other embodiments, the text visualization system 1000 can be implemented in whole, or in part, across multiple systems. For example, one or more functions of the text visualization system 1000 can be performed by one or more servers, and one or more functions of the text visualization system 1000 can be performed by one or more client devices. The one or more servers and/or one or more client devices may generate, store, receive, and transmit any type of data used by the text visualization system 1000, as described herein.

In one implementation, the one or more client devices can include or implement at least a portion of the text visualization system 1000. In other implementations, the one or more servers can include or implement at least a portion of the text visualization system 1000. For instance, the text visualization system 1000 can include an application running on the one or more servers or a portion of the text visualization system 1000 can be downloaded from the one or more servers. Additionally or alternatively, the text visualization system 1000 can include a web hosting application that allows the client device(s) to interact with content hosted at the one or more server(s).

For example, upon a client device accessing a webpage or other web application hosted at the one or more servers, in one or more embodiments, the one or more servers can provide access to a user interface displayed at a client device. The user interface can be used to upload a text including one or more words, one or more sentences, one or more paragraphs, one or more pages, and the like. The user interface can also display the uploaded text and a button (or other interactable object) that executes the text visualization system. Upon executing the text visualization system, the client device transmits the uploaded text to the one or more servers to perform the methods and processes described above. As a result, the one or more servers can provide, to the client device, one or more images corresponding to text identified as being visual text. The one or more servers can also update the text to include the one or more images (e.g., next to a paragraph including a sentence identified as being visual text, embedded, using a hyperlink, in a sentence identified as being visual text, etc.). The updated text and/or one or more images corresponding to text identified as being visual text is displayed to a user using the client device.

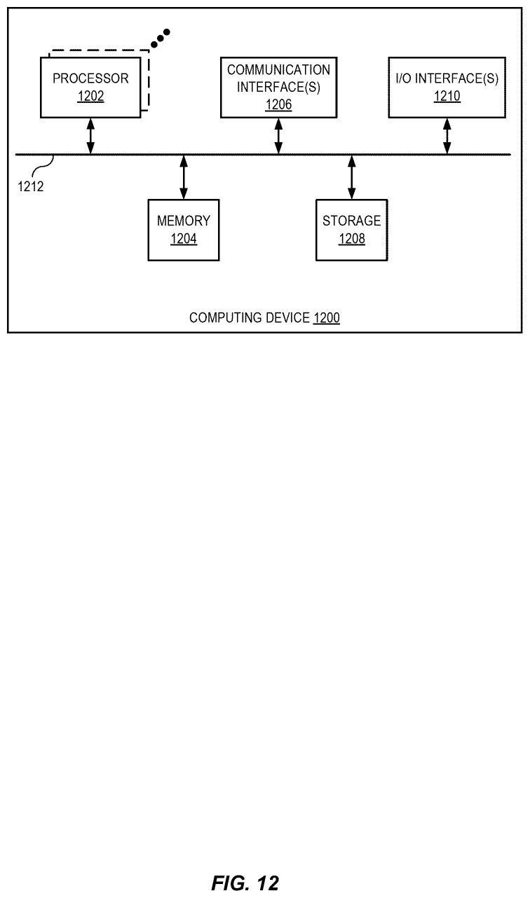

The server(s) and/or client device(s) may communicate using any communication platforms and technologies suitable for transporting data and/or communication signals, including any known communication technologies, devices, media, and protocols supportive of remote data communications, examples of which will be described in more detail below with respect to FIG. 12. In some embodiments, the server(s) and/or client device(s) communicate via one or more networks. A network may include a single network or a collection of networks (such as the Internet, a corporate intranet, a virtual private network (VPN), a local area network (LAN), a wireless local network (WLAN), a cellular network, a wide area network (WAN), a metropolitan area network (MAN), or a combination of two or more such networks. The one or more networks will be discussed in more detail below with regard to FIG. 12.

The server(s) may include one or more hardware servers (e.g., hosts), each with its own computing resources (e.g., processors, memory, disk space, networking bandwidth, etc.) which may be securely divided between multiple customers (e.g. client devices), each of which may host their own applications on the server(s). The client device(s) may include one or more personal computers, laptop computers, mobile devices, mobile phones, tablets, special purpose computers, TVs, or other computing devices, including computing devices described below with regard to FIG. 12.

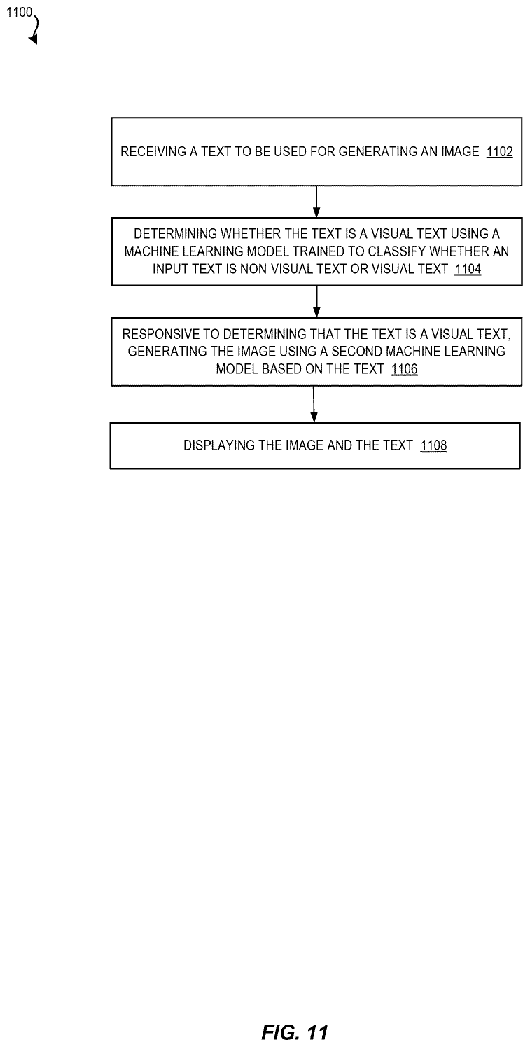

FIGS. 1-10, the corresponding text, and the examples, provide a number of different systems and devices that allow a user to generate a text augmented with images corresponding to visual text. In addition to the foregoing, embodiments can also be described in terms of flowcharts comprising acts and steps in a method for accomplishing a particular result. For example, FIG. 11 illustrates a flowchart of an exemplary method in accordance with one or more embodiments. The method described in relation to FIG. 11 may be performed with fewer or more steps/acts or the steps/acts may be performed in differing orders. Additionally, the steps/acts described herein may be repeated or performed in parallel with one another or in parallel with different instances of the same or similar steps/acts.

FIG. 11 illustrates a flowchart 1100 of a series of acts in a method of obtaining images for text identified as being visual, in accordance with one or more embodiments. In one or more embodiments, the method 1100 is performed in a digital medium environment that includes the text visualization system 1000. The method 1100 is intended to be illustrative of one or more methods in accordance with the present disclosure and is not intended to limit potential embodiments. Alternative embodiments can include additional, fewer, or different steps than those articulated in FIG. 11.

As illustrated in FIG. 11, the method 1100 includes an act 1102 of receiving a text to be used for generating an image. The text to be used for generating an image may be any digital text file including one or more paragraphs or collections of text. For example, the text may be digital text such as a document, a book, a poster, a website, and the like. The text to be used for generating the image may be one or more strings, characters, sentences, phrases, paragraphs, and the like.

As illustrated in FIG. 11, the method 1100 includes an act 1104 of determining whether the text is a visual text using a machine learning model trained to classify whether an input text is non-visual text or visual text. As described herein, text is classified as visual text responsive to the visual score of the text satisfying a visual text threshold. As described herein, a machine learning model (e.g., CLIP) determines the visual text score. The CLIP model is trained using an adapted contrastive learning objective function to pair visual text with the corresponding image. Additionally, the CLIP model is trained using the adapted contrastive learning objective function to pair non-visual text with a null image. In operation, using the adapted objective function, the CLIP model learns semantic relevance between images and text embeddings. By training the CLIP model to anchor non-visual text to the null image, during inference, the CLIP model can identify non-visual text by identifying sentences with a high similarity to that of the null image. For example, the CLIP model may take the cosine similarity of each sentence of a page and compare the sentence to the null image. Subsequently, the CLIP model can identify visual text by determining sentences that are dissimilar to the null image (e.g., a reciprocal of a similarity score).

As illustrated in FIG. 11, the method 1100 includes an act 1106 of responsive to determining that the text is a visual text, generating the image using a second machine learning model based on the text. As described herein, only visual text is subsequently processed. For example, an image manager obtains an image using text classified as visual text. In some embodiments, the image manager obtains the image by querying one or more data stores for an image using the visual text identified. In other embodiments, the image manager generates the image using the visual text. For example, the image manager may be any generative AI module configured to generate an image using the visual text as a prompt.

As illustrated in FIG. 11, the method 1100 includes an act 1108 of displaying the image and the text. For example, a document manager positions the obtained image near the visual text. The obtained image may be placed in the middle of a paragraph including the identified visual text, embedded, using a hyperlink for instance, in the identified visual text, and the like. To position the obtained image, the document manager may modify one or more attributes of the text such as font size, font, etc. Additionally or alternatively, the document manager modifies one or more attributes of the document including the text such as the document margin.

Embodiments of the present disclosure may comprise or utilize a special purpose or general-purpose computer including computer hardware, such as, for example, one or more processors and system memory, as discussed in greater detail below. Embodiments within the scope of the present disclosure also include physical and other computer-readable media for carrying or storing computer-executable instructions and/or data structures. In particular, one or more of the processes described herein may be implemented at least in part as instructions embodied in a non-transitory computer-readable medium and executable by one or more computing devices (e.g., any of the media content access devices described herein). In general, a processor (e.g., a microprocessor) receives instructions, from a non-transitory computer-readable medium, (e.g., a memory, etc.), and executes those instructions, thereby performing one or more processes, including one or more of the processes described herein.

Computer-readable media can be any available media that can be accessed by a general purpose or special purpose computer system. Computer-readable media that store computer-executable instructions are non-transitory computer-readable storage media (devices). Computer-readable media that carry computer-executable instructions are transmission media. Thus, by way of example, and not limitation, embodiments of the disclosure can comprise at least two distinctly different kinds of computer-readable media: non-transitory computer-readable storage media (devices) and transmission media.

Non-transitory computer-readable storage media (devices) includes RAM, ROM, EEPROM, CD-ROM, solid state drives (“SSDs”) (e.g., based on RAM), Flash memory, phase-change memory (“PCM”), other types of memory, other optical disk storage, magnetic disk storage or other magnetic storage devices, or any other medium which can be used to store desired program code means in the form of computer-executable instructions or data structures and which can be accessed by a general purpose or special purpose computer.

A “network” is defined as one or more data links that enable the transport of electronic data between computer systems and/or modules and/or other electronic devices. When information is transferred or provided over a network or another communications connection (either hardwired, wireless, or a combination of hardwired or wireless) to a computer, the computer properly views the connection as a transmission medium. Transmissions media can include a network and/or data links which can be used to carry desired program code means in the form of computer-executable instructions or data structures and which can be accessed by a general purpose or special purpose computer. Combinations of the above should also be included within the scope of computer-readable media.

Further, upon reaching various computer system components, program code means in the form of computer-executable instructions or data structures can be transferred automatically from transmission media to non-transitory computer-readable storage media (devices) (or vice versa). For example, computer-executable instructions or data structures received over a network or data link can be buffered in RAM within a network interface module (e.g., a “NIC”), and then eventually transferred to computer system RAM and/or to less volatile computer storage media (devices) at a computer system. Thus, it should be understood that non-transitory computer-readable storage media (devices) can be included in computer system components that also (or even primarily) utilize transmission media.

Computer-executable instructions comprise, for example, instructions and data which, when executed at a processor, cause a general-purpose computer, special purpose computer, or special purpose processing device to perform a certain function or group of functions. In some embodiments, computer-executable instructions are executed on a general-purpose computer to turn the general-purpose computer into a special purpose computer implementing elements of the disclosure. The computer executable instructions may be, for example, binaries, intermediate format instructions such as assembly language, or even source code. Although the subject matter has been described in language specific to structural features and/or methodological acts, it is to be understood that the subject matter defined in the appended claims is not necessarily limited to the described features or acts described above. Rather, the described features and acts are disclosed as example forms of implementing the claims.

Those skilled in the art will appreciate that the disclosure may be practiced in network computing environments with many types of computer system configurations, including, personal computers, desktop computers, laptop computers, message processors, hand-held devices, multi-processor systems, microprocessor-based or programmable consumer electronics, network PCs, minicomputers, mainframe computers, mobile telephones, PDAs, tablets, pagers, routers, switches, and the like. The disclosure may also be practiced in distributed system environments where local and remote computer systems, which are linked (either by hardwired data links, wireless data links, or by a combination of hardwired and wireless data links) through a network, both perform tasks. In a distributed system environment, program modules may be located in both local and remote memory storage devices.

Embodiments of the present disclosure can also be implemented in cloud computing environments. In this description, “cloud computing” is defined as a model for enabling on-demand network access to a shared pool of configurable computing resources. For example, cloud computing can be employed in the marketplace to offer ubiquitous and convenient on-demand access to the shared pool of configurable computing resources. The shared pool of configurable computing resources can be rapidly provisioned via virtualization and released with low management effort or service provider interaction, and then scaled accordingly.

A cloud-computing model can be composed of various characteristics such as, for example, on-demand self-service, broad network access, resource pooling, rapid elasticity, measured service, and so forth. A cloud-computing model can also expose various service models, such as, for example, Software as a Service (“SaaS”), Platform as a Service (“PaaS”), and Infrastructure as a Service (“IaaS”). A cloud-computing model can also be deployed using different deployment models such as private cloud, community cloud, public cloud, hybrid cloud, and so forth. In this description and in the claims, a “cloud-computing environment” is an environment in which cloud computing is employed.

FIG. 12 illustrates, in block diagram form, an exemplary computing device 1200 that may be configured to perform one or more of the processes described above. One will appreciate that one or more computing devices such as the computing device 1200 may implement the text visualization system. As shown by FIG. 12, the computing device can comprise a processor 1202, memory 1204, one or more communication interfaces 1206, a storage device 1208, and one or more I/O devices/interfaces 1210. In certain embodiments, the computing device 1200 can include fewer or more components than those shown in FIG. 12. Components of computing device 1200 shown in FIG. 12 will now be described in additional detail.

In particular embodiments, processor(s) 1202 includes hardware for executing instructions, such as those making up a computer program. As an example, and not by way of limitation, to execute instructions, processor(s) 1202 may retrieve (or fetch) the instructions from an internal register, an internal cache, memory 1204, or a storage device 1208 and decode and execute them. In various embodiments, the processor(s) 1202 may include one or more central processing units (CPUs), graphics processing units (GPUs), field programmable gate arrays (FPGAs), systems on chip (SoC), or other processor(s) or combinations of processors.

The computing device 1200 includes memory 1204, which is coupled to the processor(s) 1202. The memory 1204 may be used for storing data, metadata, and programs for execution by the processor(s). The memory 1204 may include one or more of volatile and non-volatile memories, such as Random Access Memory (“RAM”), Read Only Memory (“ROM”), a solid state disk (“SSD”), Flash, Phase Change Memory (“PCM”), or other types of data storage. The memory 1204 may be internal or distributed memory.

The computing device 1200 can further include one or more communication interfaces 1206. A communication interface 1206 can include hardware, software, or both. The communication interface 1206 can provide one or more interfaces for communication (such as, for example, packet-based communication) between the computing device and one or more other computing devices 1200 or one or more networks. As an example and not by way of limitation, communication interface 1206 may include a network interface controller (NIC) or network adapter for communicating with an Ethernet or other wire-based network or a wireless NIC (WNIC) or wireless adapter for communicating with a wireless network, such as a WI-FI. The computing device 1200 can further include a bus 1212. The bus 1212 can comprise hardware, software, or both that couples components of computing device 1200 to each other.

The computing device 1200 includes a storage device 1208 includes storage for storing data or instructions. As an example, and not by way of limitation, storage device 1208 can comprise a non-transitory storage medium described above. The storage device 1208 may include a hard disk drive (HDD), flash memory, a Universal Serial Bus (USB) drive or a combination these or other storage devices. The computing device 1200 also includes one or more input or output (“I/O”) devices/interfaces 1210, which are provided to allow a user to provide input to (such as user strokes), receive output from, and otherwise transfer data to and from the computing device 1200. These I/O devices/interfaces 1210 may include a mouse, keypad or a keyboard, a touch screen, camera, optical scanner, network interface, modem, other known I/O devices or a combination of such I/O devices/interfaces 1210. The touch screen may be activated with a stylus or a finger.

The I/O devices/interfaces 1210 may include one or more devices for presenting output to a user, including, but not limited to, a graphics engine, a display (e.g., a display screen), one or more output drivers (e.g., display drivers), one or more audio speakers, and one or more audio drivers. In certain embodiments, I/O devices/interfaces 1210 is configured to provide graphical data to a display for presentation to a user. The graphical data may be representative of one or more graphical user interfaces and/or any other graphical content as may serve a particular implementation.

In the foregoing specification, embodiments have been described with reference to specific exemplary embodiments thereof. Various embodiments are described with reference to details discussed herein, and the accompanying drawings illustrate the various embodiments. The description above and drawings are illustrative of one or more embodiments and are not to be construed as limiting. Numerous specific details are described to provide a thorough understanding of various embodiments.

Embodiments may include other specific forms without departing from its spirit or essential characteristics. The described embodiments are to be considered in all respects only as illustrative and not restrictive. For example, the methods described herein may be performed with less or more steps/acts or the steps/acts may be performed in differing orders. Additionally, the steps/acts described herein may be repeated or performed in parallel with one another or in parallel with different instances of the same or similar steps/acts. The scope of the invention is, therefore, indicated by the appended claims rather than by the foregoing description. All changes that come within the meaning and range of equivalency of the claims are to be embraced within their scope.

In the various embodiments described above, unless specifically noted otherwise, disjunctive language such as the phrase “at least one of A, B, or C,” is intended to be understood to mean either A, B, or C, or any combination thereof (e.g., A, B, and/or C). As such, disjunctive language is not intended to, nor should it be understood to, imply that a given embodiment requires at least one of A, at least one of B, or at least one of C to each be present.

We claim:

1. A method comprising:
receiving a text to be used for generating an image;
determining whether the text is a visual text using a machine learning model trained to classify whether an input text is non-visual text or visual text;
responsive to determining that the text is a visual text, generating the image using a second machine learning model based on the text; and
displaying the image and the text.

2. The method of claim 1, wherein determining whether the text is the visual text further comprises:
determining that a visual score of the text satisfies a visual text threshold.

3. The method of claim 1, wherein the machine learning model is trained to classify visual text using contrastive learning.

4. The method of claim 3, wherein the machine learning model is trained to classify visual text using contrastive learning based on a positive pair including an image and a similar sentence and a negative pair including a null image and a dissimilar sentence.

5. The method of claim 1, wherein generating the image using the second machine learning model based on the text further comprises:
receiving, by the second machine learning model, a text embedding of the visual text determined from the machine learning model.

6. The method of claim 5, wherein the second machine learning model is a generative machine learning model.

7. The method of claim 1, wherein the text is a sentence.

8. The method of claim 1, further comprising:
determining that another text is non-visual text using the machine learning model; and
displaying the another text.

9. The method of claim 8, further comprising:
determining that a visual score of the another text does not satisfy a visual text threshold.

10. A method comprising:
obtaining training data including an image, a sentence corresponding to the image, a null image, and a sentence corresponding to the null image; and
training a machine learning model using contrastive learning and the training data to classify whether a text is visual text or non-visual text.

11. The method of claim 10, wherein training the machine learning model further comprises:
determining whether each page in a plurality of pages includes the image using an object detection algorithm, wherein each page includes a plurality of sentences.

12. The method of claim 11, wherein training the machine learning model further comprises:
determining a positive pair of the training data by:
selecting the image, and
selecting a sentence of the plurality of sentences that satisfies a similarity threshold using an embedding of the sentence and an embedding of the image, the selected sentence corresponding to the image.

13. The method of claim 11, wherein training the machine learning model further comprises:
determining a negative pair of the training data by:
selecting a sentence of the plurality of sentences that satisfies a negative similarity threshold to the image, the selected sentence corresponding to the null image, and
obtaining the null image.

14. The method of claim 13, wherein training the machine learning model further comprises:
generating a randomly generated null image by randomly selecting a value of a pixel in the null image.

15. The method of claim 13, wherein the obtained null image is a common null image.

16. The method of claim 10, wherein training the machine learning model further comprises modifying a contrastive loss objective function to include a first term directed to learning a sentence and a corresponding image, and a second term directed to learning another sentence and a null image.

17. A non-transitory computer-readable medium storing executable instructions, which when executed by a processing device, cause the processing device to perform operations comprising:
receiving a text;
determining that the text is visual text using a machine learning model trained to compare an embedding of the text to an embedding of a null image, wherein the machine learning model determines that the text is visual text responsive to determining that the embedding of the text is dissimilar to the embedding of the null image; and
generating an image associated with the text using the embedding of the text.

18. The non-transitory computer-readable medium of claim 17, wherein the machine learning model is trained based on contrastive leaning.

19. The non-transitory computer-readable medium of claim 17, wherein determining that the embedding of the text is dissimilar to the embedding of the null image further comprises:
determining that a reciprocal of a similarity of the embedding of the null image and the embedding of the text satisfy a similarity threshold.

20. The non-transitory computer-readable medium of claim 17, wherein the text is a sentence.
